(19) United States
(12) Patent Application Publication
(10) Pub. No.: US 2002/0031449 A1
(43) Pub. Date: Mar. 14, 2002

(54) Multiple-container systems with improved sensitivity for optical analysis

(75) Inventors: Frank Loscher, Heidelberg (DE); Dirk Maier, Heidelberg (DE); Peter Schubert, Heidelberg (DE); Stefan Seeger, Heidelberg (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: MOLECULAR MACHINES & INDUSTRIES GMBH

(21) Appl. No.: 09/860,439

(22) Filed: May 21, 2001

Related U.S. Application Data
(63) Continuation of application No. PCT/EP99/08891, filed on Nov. 19, 1999.

(30) Foreign Application Priority Data
Nov. 20, 1998 (DE) 19853640.2

(51) Int. Cl. B01L 3/00

(52) U.S. Cl. 422/102

(57) ABSTRACT

The invention relates to multiple-container systems and to the use of same for optical assays. The invention relates in particular to a multiple-container system comprising a container wall matrix (1) with continuous cavities and one or more optically transparent base plates (2) joined to the container wall matrix.aid system is characterized in that the base plates are coated with a film (3) having functional groups suitable for the covalent immobilization of molecules. The film on the base plate is preferably a Langmuir-Blodgett film, and preferably a Langmuir-Blodgett film on cellulose basis. The invention further relates to multiple-container systems comprising a container wall matrix with continuos cavities and one or more optically transparent base plates joined to the wall matrix. Said systems are characterized in that the base plates are coated with a film derivatized with receptor molecules or molecules presenting low non-specific protein adsorption.

The present invention relates to multi-well assemblies and use thereof.

Multi-well assemblies such as e.g. microtiter plates have become a standard in biochemical analysis since they feature the advantage, more particularly, of permitting automated analysis or assaying of multiple samples in parallel, including for example ELISA (Enzyme-Linked Immunosorbent Assay) testing, determining the concentration of chemicals, proteins and DNA or determining the α, β and/or γ radiation in scintillation, fluorescence, phosphorescence or luminescence measurements etc. Furthermore, multi-well assemblies have proven to be of advantage in automated cell culture analysis. As a rule, analysis is done such that the samples in the multi-well assemblies are irradiated with light in the UV/VIS wavelength range and the absorption or emission of the samples determined by suitable detectors. However, the sensitivity of these measurements was limited by the optical properties of the plastics, typically polystyrene, used for making the multi-well assemblies. This is why attempts have been made more recently to improve the optical properties of the multi-well assemblies by selecting suitable materials or selecting suitable geometries of the multi-well assemblies. Thus, EP 0 797 088 A1 discloses multi-well assemblies having trays of plastics materials which are highly transparent to UV light. The sensitivity of such multi-well assemblies continues to remain unsatisfactory for a plurality of assays in which minute quantities of the sample down to a single molecule are to be analysed, such as, for example, substance libraries produced by combinatorial chemistry.

It is thus the object in accordance with the invention to provide multi-well assemblies having an improved sensitivity for optical methods of analysis.

This object is achieved in accordance with the invention by a multi-well assembly comprising a well wall array (1) having continuous wells and one or more tray(s) (2) affixed thereto, characterized in that the tray(s) (2) is/are coated with a film (3) having functional groups suitable for covalent immobilization of molecules.

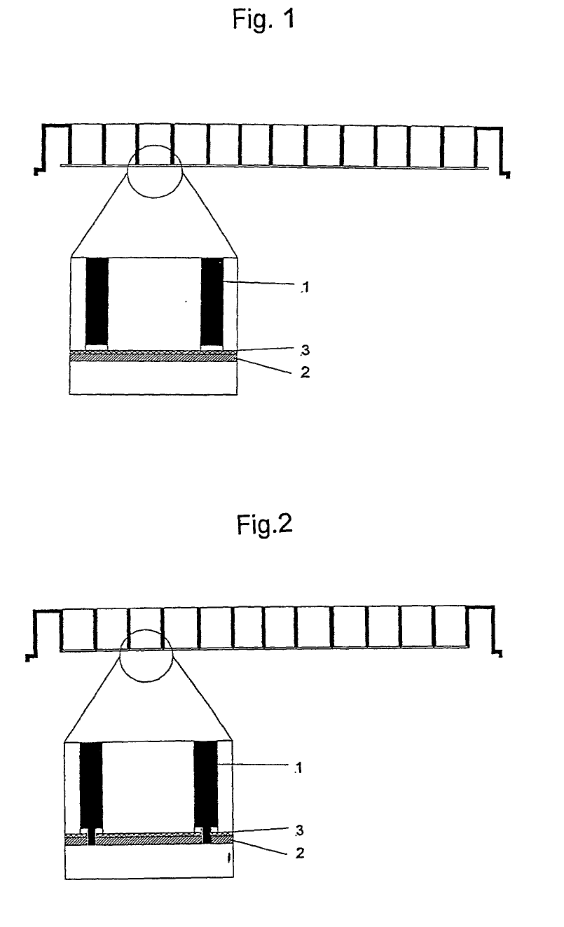

FIGS. 1 and 2 show preferred multi-well assemblies in accordance with the invention. FIG. 1 shows a multi-well assembly in accordance with the invention comprising a well wall array (1) having continuous wells and a tray (2) affixed thereto which is coated with the film (3). FIG. 2 shows a multi-well assembly in accordance with the invention comprising a well wall array (1) having continuous wells and several trays (2) affixed thereto which are coated with the film (3), one tray (2) being provided per well of the well wall array.

Unlike prior art multi-well assemblies the multi-well assemblies in accordance with the invention permit independent control of the surface properties of the tray of the multi-well assembly through which or at which optical analysis is implemented, and the well wall merely serving to hold the fluid and which as a rule is irrelevant to analysis. It is this ability to control the surface properties of the tray that surprisingly results in the sensitivity of the optical methods of analysis with multi-well assemblies being enhanced.

There is no limit to the number of wells in the multi-well assembly in accordance with the invention which covers multi-well assemblies having 24 (4*6), 48 (6*8), 96 (8*12), 384 (16*24), 864 (24*36) or 1536 (32*48) wells, but is not limited to these configurations. However, the benefits to be had from the invention become all the more significant the higher the number of wells, since this involves an increasing surface/volume ratio, i.e. the surface effects become all the more relevant, the higher the number of wells. The dimensions of the multi-well assemblies are oriented preferably to SBS (Society of Biomolecular Screening) standards, i.e. the multi-well assembly is preferred 86 mm wide and 128 mm long, irrelevant of the number of wells.

The well wall array (1) to be used in accordance with the invention is made preferably of a plastics material, more particularly of one such plastics material comprising a low non-specific adsorption for the substance to be analysed, such as e.g. DNA or proteins. Preferred materials for the well wall array include polystyrene, polycarbonate, polythene and/or polypropylene. Also suitable for use as the well wall array in accordance with the invention are plastics whose surfaces are coated with substances forming a film on the well wall array which reduces the adsorption of the analysis at the well wall array. Suitable substances in this respect include in particular bovine serum albumin, fluorinated hydrocarbons, oligoethylene oxide treated polymers such as, for example, polymers of the pluronics substance class as well as polysaccharides such as e.g. cellulose and dextran derivatives. Furthermore, the plastics of the well wall array (1) preferably contains an optical non-transparent substance such as titanium dioxide or lamp black to prevent optical cross-talk between individual wells. The face of the well wall array (1) connecting the tray(s) (2) is as a rule planar, especially where a large number of wells is concerned. When a low number of wells is involved and thus as a rule a larger sample for each well, then for each well of array thereof, for example 4 or 9 wells, a cavity in the size of the tray to be analysed may be used, i.e. in this case a tray being used for each well or array thereof. Although this is not preferred as regards manufacture, one such multi-well assembly in accordance with the invention may be preferred for its enhanced sensitivity since optical cross-talk between individual wells along the tray can be prevented. The wells of the well wall array used in accordance with the invention may be round, rectangular or square, round wells being preferred in accordance with the invention since these feature a smaller surface than square wells for the same volume and thus result in less adsorption of the analyte for properties otherwise the same.

The optically transparent tray (2) of the multi-well assembly for use in accordance with the invention permits advantageously particularly high transmission in the wavelength range in which assaying is implemented. For a plurality of optical measurements particularly quartz glass or borosilicate glass is preferred, although other materials such as e.g. 4-methyl-pentene-l-polymer TPX® of Mitsui Petrochemical Industries, Japan, or polymethyl methacrylate may be used. The thickness of the tray (2) used in accordance with the invention is preferably low, less than 200 μm thick, more particularly 130 to 170 μm and most preferably 150 μm thick. The tray should be as thin as possible especially when strongly focussed light or objective lenses having a high numerical aperture are used in assaying, such as, for example, in fluorescence correlation spectroscopy. Trays having a low surface roughness are particularly preferred. The dimensions of the tray depend on the number of wells when one tray is used per well. In a 24-well array the size may be approx. 17 mm*17 mm. When only one tray is used for the multi-well assembly in accordance with the invention the size of the tray will then normally be75 mm*115 mn.

The film (3) used for coating the trays(s) of the multi-well assembly in accordance with the invention including functional groups suitable for molecular covalent immobilization permits tailored modification of the tray surface, i.e. the surface relevant to analysis, surprisingly enhancing the sensitivity of optical measurements.

There is no restriction to the nature of the film (3) employed as long as it comprises suitable functional groups and includes, for example, films of silane, Langmuir-Blodgett films and hydrogel films as well as for example films of dextran.

The functional groups on this film are not restricted and include, for example, hydroxy, amino, aldehyde and carboxy groups. Preferably these groups are provided protected, i.e. requiring dissociation of a protection group prior to covalent immobilization of the molecules. Suitable protection groups are known to the person skilled in the art.

The film used in accordance with the invention is preferably a Langmuir-Blodgett film, more particularly a two- or three-dimensional cross-linkable Langmuir-Blodgett film, most preferably a polysaccharide or cellulose-based Langmuir-Blodgett film. Advantageously, the film used in accordance with the invention is photochemically cross-linkable. The Langmuir-Blodgett films used in accordance with the invention have the advantage that subsequent to receptor immobilization they feature a high specific adsorption for a low non-specific adsorption, are locationally stable whilst providing a highly defined surface topographically.

The preferred polysaccharide or cellulose derivatives for the Langmuir-Blodgett film feature a degree of polymerization of better than 5 and are most preferably mixtures of cellulose ether comprising a) at least one hydrophobic substitute and b) at least one substitute containing a nitrogen atom.

In preferred embodiments the mixtures of cellulose ether comprise as substitute a) a trialkylsilyl group and as substitute b) an aminoalkyl group, the alkyl radical having more particularly in substitute a) 1 or 2 C atoms and in substitute b) 2 to 8 C atoms. In addition the polysaccharide derivate may also contain c) at least one further substitute as the basis for a group suitable for photochemical, radical or thermal cross-linking.

The compounds involved in the preferred cellulose ether mixtures are mainly those in which some of the OH groups of the cellulose basic structure on the H are replaced by organic or organosilyl groups, i.e. the atom directly adjoining the O is a C or Si. In addition, this term may also be understood to include further derivatives as the basis for further additional substitutes (more particularly at the O of the OH group) for example substitute c) being one such. In the concrete molecules (cf. Lothar Brandt in Ullmann's Enyclopedia of Industrial Chemistry, Volume. A5, 2nd edition, under “cellulose ethers”, page 461 et seq.) it is not every single molecule unit (anhydroglucose unit) in the cellulose ether molecule at one or more OH groups that needs to be substituted, the compound term relating instead to the entirety of the molecules or molecule units, i.e. it representing an average value term; not more than 3 OH groups being substitutable per molecule unit in general. As regards the production or behaviour of the cellulose derivatives containing the substitutes a) or c) (but no b)) reference is made to Frank Löscher et al., Proc. SPIE Vol. 2928, 1996, pages 209 to 219 and to Dieter Klemm et al., Z.Chem., 24th Edition (1984), No. 2, page 62 in “4-dimethylamino-pyridin-katalysierte Synthese von Celluloseestem über organolösliche Synthese von Celluloseestern über organolösliche Trimethylcellulose”.

For coating the tray at least one monomolecular film of the polysaccharide derivative, preferably 2 to 10 monomolecular films thereof, are applied to the tray, these comprising as substitute a) preferably a hydrophobic substitute with alkyl, alkenyl, aryl, alkylsilyl, alkensilyl and/or arylsilyl radicals, but also other substitutes permitting film-coating surfaces by the Langmuir-Blodgett (LB) and/or Langmuir-Blodgett-Schäfer (LB S) system.

Applying this film may be done by incubation in a solution, by a self-assembly (SA) process or preferably by the Langmuir-Blodgett or Langmuir-Blodgett-Schäfer system. The polysaccharide derivatives are suitable for bonding to both hydrophilic and hydrophobic surfaces and thus this class of substances can be applied and used as the surface-modifying film.

These films may be additional stabilized by incorporating photopolymerizable or thermally polymerizable groups in the molecule(s), e.g. cinnamoyl groups, although all other groups known in chemistry are applicable since they provide cross-linkable stabilization of the film by polymerization, before, during and after transfer.

In this arrangement, the polymerizable groups may be applied either to the aforementioned polysaccharide derivative or, however, exist in the form of a further molecule applied mixed with the polysaccharide derivative on or in the film. Polymerization may take place within a monolayer; when, however, a plurality of monolayers are provided stacked, polymerization may also take place between the molecules of individual layers.

The multi-well assembly in accordance with the invention can be produced as follows:

The tray is coated with the film, for example with the Langmuir-Blodgett film as described above. In a separate operation a premolded well wall array, injection-molded in polystyrene, for example, is first cleaned, for example ultrasonically. After this, the well wall array is dipped preferably into a solution containing a substance which diminishes the adsorption of analytes such as protein or DA at the wall of the well wall array, such as bovine serum albumin, the well wall array then being dried.

An adhesive, for example a silicone rubber, epoxy resin or an acrylate adhesive (e.g. Loctite) is applied, for example by means of a roll, to the edges of the well wall array intended to form the contact surface area for affixing the tray.

Particularly preferred are photoactivatable single-component adhesives. The thus pretreated well wall array is carefully pressed onto the tray coated with the Langmuir-Blodgett film. As an alternative, the adhesive may be directly film-screened onto the tray in a pattern corresponding to the contact surface area with the well wall array. This thus produces the multi-well assembly in accordance with the invention. Preferably the difference in the level of the bonded tray to that of the outer edge of the plastics body is not more than approx. 1 mm, to ensure that all wells of the multi-well assembly in accordance with the invention can be sensed at the tray side with no steric hindrance of the sensing optics by the edge of the well wall array.

Once the multi-well assembly in accordance with the invention has been produced, the surface is preferably protected by a lid and/or a foil. The lid is preferably designed so that it is automatically correctly positioned on top of a multi-well assembly in accordance with the invention, it furthermore permitting automatically correct positioning of stacks of multi-well assemblies. The size of the lid is preferably roughly 86 mm*128 mm*8 mm. Using a foil has the advantage that the surface of the tray also remains protected when, for instance, fluid is introduced into a well by means of a syringe with a needle piercing the foil.

On the tray of a multi-well assembly in accordance with the invention molecules can be covalent coupled for implementing optical assays which, depending on the nature of the analysis method or assay, determine the surface properties, a distinction being made in this respect between homogeneous and heterogeneous assays, i.e. assays in which the analyte is available in solution, and assays in which the analyte, such as e.g. a receptor or ligand, binds to a ligand or receptor at a surface. Belonging to the homogeneous assays in which the multi-well assembly in accordance with the invention is particularly of advantage to use, are fluorescence correlation, fluorescent polarisation immunosorbent and Forster energy transfer assays. Belonging to the heterogeneous assays in which the multi-well assembly in accordance with the invention is particularly of advantage to use, are all optical assays in which it is of advantage to concentrate the analyte at the surface of the tray, such as e.g. evanescence assays or assays in which the surface is scanned with a highly focussed laser beam to stimulate fluorescence.

Depending on the nature of the assay the surface film on the tray is derivatized with molecules. Whilst in homogeneous assays the aim of immobilizing molecules is to achieve minimum adsorption of the analyte to thus ensure high mobility of the analyte at the surface, in heterogeneous assays the aim is to immobilize the analyte. This is why in homogeneous assays the film is modified preferably with, for example, bovine serum albumin, substances containing chains of oligoethylene oxide, fluorinated hydrocarbons or polysaccharides such as cellulose or dextran derivatives, whereas in heterogeneous assays substances are coupled to the film capable of binding the analyte. Depending on the nature of the analyte the person skilled in the art knows which substances are suitable for selection in prompting binding of the analyte, for example, DNA, proteins such as e.g. antibodies or peptides.

Covalent immobilization of the molecules may be done directly at the reactive groups of the surface film or following previous dissociation of the protective groups. Where use is made of the aforementioned Langmuir-Blodgett film the existing aminoalkyl groups are suitable, for example, for directly coupling molecules. The aminoalkyl groups serve as nucleophilic agents and form covalent bonds with molecules carrying electrophilic groups. On the other hand, where the films comprise silyl groups, e.g. trialkyl, triaryl or trialkenylsilyl groups, the surface properties can be altered such that the silyl groups are dissociated after coating so that hydroxy groups remain, this being attainable e.g. by exposure to acid. These hydroxy groups may the serve as functional groups for covalent immobilization.

Once the molecules have been immobilized the assays can be implemented by ways and means known to the person skilled in the art.

### Comparitive Tests

### (1.) EXAMPLE 1

(a) A glass plate was coated with a layer of aminoalkyl-trimethylsilyl-ether cellulose (ATMSC) and subsequently with a layer of cinnamoyltrimethylsilyl-ether cellulose (CTMSC), reference being made to “ultrathin cellulose based layers for detection of single antigen molecules, Advanced Materials 1998, 10, No. 13” for details as to the coating method. Streptavidin was then coupled to the cellulose surface via Lemieux oxidation (see attached publication).

(b) Parallel thereto a plastics frame, i.e. the well wall array was incubated for 1 hour at room temperature with 0.2 mg/ml bovine serum albumin.

(c) Subsequently, the plastics frame was cemented to the cellulose-modified glass plate.

(d) For the measurements 0.08 ml 10⁻¹⁰ M Biotin CY5 conjugate, synthesized at the University of Regensburg, was then pipetted into the wells of the multi-well assembly and incubated therein for 1 hour at room temperature. This was followed by washing twice with phosphate buffers (PBS) and the binding of the Biotin CY5 conjugate to the surface was measured by confocal fluorescence spectroscopy using a LB8® counter (MMI GmbH, Heidelberg). 10 lines of each 0.5 mm and 2,000 measurement points per line were measured. Measurement time per point was 0.5 msec. 300 counts were weighted as an event. Measurement was implemented twice.

(e) The values of 43,892 and 46,253 events were obtained.

### 2. EXAMPLE 2

The multi-well assembly was produced the same as in example 1, except that the plastics frame was incubated with 0.1 mg/ml streptavidin instead of with 0.2 mg/ml bovine serum albumin. Subsequent measurement was likewise implemented the same as in the example in accordance with the invention, except that values from 1,663 events and 2,170 events respectively were obtained.

1. A multi-well assembly comprising a well wall array (1) having continuous wells and one or more optically transparent trays (2) affixed thereto, characterized in that exclusively said tray(s) is/are coated with at least one monomolecular layer of a polysaccharide derivative (3) having functional groups suitable for covalent immobilization of molecule.

2. The multi-well assembly as set forth in claim 1, characterized in that said well wall array (1) is made of plastics.

3. The multi-well assembly as set forth in any of the preceding claims, characterized in that said well wall array (1) is made of material non-transparent to light.

4. The multi-well assembly as set forth in any of the preceding claims, characterized in that said tray(s) is/are made of quartz glass.

5. The multi-well assembly as set forth in any of the preceding claims, characterized in that said at least one monomolecular layer of a polysaccharide derivative (3) is applied by a self-assembly process or by the Langmuir-Blodgett system.

6. The multi-well assembly as set forth in any of the preceding claims, characterized in that said at least one monomolecular layer of a polysaccharide derivative (3) is a cellulose-based Langmuir-Blodgett film.

7. The multi-well assembly as set forth in any of the preceding claims, characterized in that said tray(s) (2) is/are affixed to said well wall array by means of an adhesive.

8. The multi-well assembly as set forth in claim 7, characterized in that said adhesive is a light-curing adhesive.

9. A multi-well assembly comprising a well wall array having continuous wells and one or more optical transparent tray(s) affixed thereto, characterized in that exclusively said tray(s) is/are coated with a film which is derivatised with receptor molecules.

10. A multi-well assembly comprising a well wall array having continuous wells and one or more optical transparent tray(s) affixed thereto, characterized in that exclusively said tray(s) is/are coated with a film comprising bovine serum albumin, substances containing chains of oligoethylene oxide, fluorinated hydrocarbons or polysaccharides

11. Use of a multi-well assembly as set forth in any of the preceding claims for optical methods of analysis.

12. Method of producing a multi-well assembly as set forth in any of the claims 1 to 8 comprising the following steps:
a) applying at least one monomolecular layer of a polysaccharide derivative to said tray(s);
b) applying an adhesive to the edges of said well wall array to form the contact surface area with said tray to be affixed.
c) pressing the thus treated well wall array onto said coated tray(s).
